(19) United States
(12) Patent Application Publication
(10) Pub. No.: US 2012/0134297 A1
(43) Pub. Date: May 31, 2012

(54) DEVICE DETECTION APPARATUS AND PROGRAM

(75) Inventor: Takuya SAKAMOTO, Kawasaki (JP)

(73) Assignee: FUJITSU LIMITED, Kawasaki-shi (JP)

(21) Appl. No.: 13/288,738

(22) Filed: Nov. 3, 2011

(30) Foreign Application Priority Data
Nov. 26, 2010 (JP) 2010-264338

(51) Int. Cl. H04W 40/24

(52) U.S. Cl. 370/254

(57) ABSTRACT

A device detection apparatus includes a multicast detection unit that uses multicast to detect a device and records address information of the detected device in a first storage unit while being associated with identification information of a currently connected network segment; and a unicast detection unit that detects the device related to the address information associated with the identification information which is different from the identification information of the currently connected network segment among the address information recorded in the first storage unit.

### CROSS-REFERENCE TO RELATED APPLICATION

This application is based upon and claims the benefit of priority of the prior Japanese Patent Application No. 2010-264338 filed on Nov. 26, 2010, the entire contents of which are incorporated herein by reference.

### FIELD

The embodiments discussed herein relate to a device detection apparatus and a device detection program, in particular, a device detection apparatus and a device detection program for detecting a device connected to a network.

### BACKGROUND

As a technical specification for collaborating with a device via a network, UPnP (Universal Plug and Play) exists. According to the UPnP, by using multicast, detection (finding) of the device and information exchange are dynamically carried out. Therefore, according to the UPnP, it is not necessary to use a server device for managing the respective devices in an integrated fashion. Also, it is not necessary for the device at the collaboration source to previously identify an IP address of the collaboration destination and the like.

With regard to the UPnP, a group called DLNA (Digital Living Network Alliance) established a DLNA guidelines for realizing a mutual connectivity based on the UPnP. A television set, an HDD recorder, a NAS (Network Attached Storage), a printer, and the like which follow the DLNA guidelines have begun to be used in homes. These devices are expected to become popular in commercial enterprises and the like if they become inexpensive because management costs are reduced as it is unnecessary to use the server device.

Related-art techniques are disclosed in Japanese Laid-open Patent Publication No. 2009-268010.

However, as described above, the UPnP uses the multicast. In the multicast, the same data is transmitted to all devices connected to a network. Like in the house, in an environment where the number of devices connected to the network is small, the network load by the multicast hardly causes a problem.

On the other hand, in an intranet environment of the commercial enterprise, a larger number of devices may be connected to the network. If the multicast is issued in the above-mentioned environment, the network load may be increased to a measurable level. In view of the above, in the environment where the larger number of devices are connected to the network, in general, a filtering is carried out by a router or the like. As a result of the filtering, a range of the distribution of the multicast is limited within one network segment. Therefore, in a case where UPnP technologies are utilized in an office environment or the like, a range of the device that can detect and collaborate is limited within the same network segment as the device at the collaboration source.

In recent years, a mobile terminal to which a wireless LAN function is mounted such as a smart phone is being utilized for business in the commercial enterprise too. Since the mobile terminal carries out a network connection while in motion, the use of the mobile terminal is continued across different network segments in many cases. However, in a case where the device collaboration is carried out in the commercial enterprise by using the mobile terminal corresponding to the UPnP, the relevant mobile terminal needs to be connected to the same network segment as the device at the collaboration destination. As a result, for example, in the office environment in the commercial enterprise or the like, the following inconveniences are expected.

For example, a LAN access point connected to the same network segment as the device desired to be collaborated is not necessarily located in a convenient location for a user. Therefore, for example, although a document saved in the NAS can be performed in the convenience of the user's own seat in the office by using a mobile terminal, saving the document may not be performed in a meeting room.

Also, in a case where two or more devices are desired to collaborate via the mobile terminal, the collaboration does not need to be established unless the relevant two or more devices are connected to the same network segment. For example, content data in the server installed outside of the meeting room may not be displayed on a network television arranged in the meeting room via the mobile terminal.

### SUMMARY

According to an aspect of an embodiment, a device detection apparatus includes a multicast detection unit that uses multicast to detect a device and records address information of the detected device in a first storage unit while being associated with identification information of a currently connected network segment; and a unicast detection unit that detects the device related to the address information associated with the identification information which is different from the identification information of the currently connected network segment among the address information recorded in the first storage unit.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a network configuration example according to a first embodiment;

FIG. 2 illustrates a hardware configuration example of a mobile terminal according to an embodiment of the present invention;

FIG. 3 illustrates a function configuration example of a mobile terminal according to the first embodiment;

FIG. 4 is a flow chart for describing an example of a process procedure executed by the mobile terminal according to the first embodiment;

FIG. 5 is a flow chart for describing an example of a process procedure of a detection process for a controlled device using unicast;

FIG. 6 illustrates a configuration example of a detecting information storage unit;

FIG. 7 illustrates an example of a response to unicast M-Search;

FIG. 8 illustrates a configuration example of a detection device information storage unit;

FIG. 9 is a flow chart for describing an example of a process procedure of a detection process for a controlled device using multicast;

FIG. 10 is a flow chart for describing an example of a process procedure of a detecting information restriction process;

FIG. 11 illustrates a first extended example of the detecting information storage unit;

FIG. 12 illustrates a second extended example of the detecting information storage unit;

FIG. 13 illustrates a network configuration example according to a second embodiment;

FIG. 14 illustrates a function configuration example of a mobile terminal according to the second embodiment;

FIG. 15 is a flow chart for describing an example of a process procedure added according to the second embodiment;

FIG. 16 illustrates a configuration example of a detection permit denial information storage unit;

FIG. 17 illustrates a display example of a detection permit denial setting screen;

FIG. 18 illustrates a function configuration example of a mobile terminal according to a third embodiment;

FIG. 19 is a flow chart for describing an example of a process procedure added according to the third embodiment;

FIG. 20 illustrates a configuration example of a segment group information storage unit; and

FIG. 21 illustrates a display example of a segment group setting screen.

### DESCRIPTION OF EMBODIMENTS

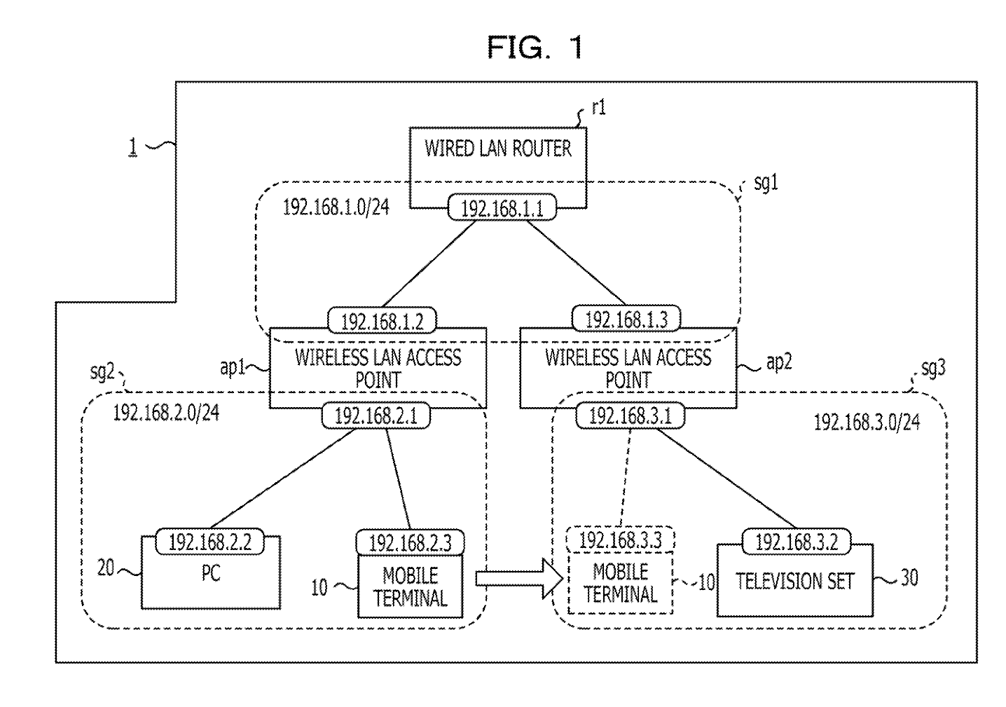

Hereinafter, embodiments of the present invention will be described in reference to the drawings. FIG. 1 illustrates a network configuration example according to a first embodiment. In a network system 1, a wired LAN router r1 is connected to each of wireless LAN access points ap1 and ap2 via a LAN (Local Area Network) cable.

Each of the wireless LAN access points ap1 and ap2 is an electric-field relay device that may function as an access point of a wireless LAN (Local Area Network). A wireless LAN router may be used as the wireless LAN access point ap1 or ap2. In a case where no distinction is made between the two wireless LAN access points, the wireless LAN access points will be referred to as “wireless LAN access point ap”.

Within a radio wave range of the wireless LAN access point ap1, a PC 20 or the like is installed. The PC 20 can communicate with another communication device in the network system 1 via the wireless LAN access point ap1.

Within a radio wave range of the wireless LAN access point ap2, a television set 30 or the like is installed. The television set 30 can communicate with another communication device in the network system 1 via the wireless LAN access point ap2.

The network system 1 further includes a mobile terminal 10. The mobile terminal 10 can perform a wireless LAN communication such as wireless LAN (Local Area Network) and is a portable-type information process apparatus that can execute a program. According to the present embodiment, the mobile terminal 10 is an example of a device detection apparatus. A mobile phone, a smart phone, a PDA (Personal Digital Assistance), a notebook-size personal computer, and the like may also be example devices of mobile terminal 10. An example is illustrated in which the mobile terminal 10 is connected to the wireless LAN access point ap1. However, the mobile terminal 10 may also be connected to the wireless LAN access point ap2 while being moved. A state is illustrated in which the mobile terminal 10 drawn by a broken line is connected to the wireless LAN access point ap2.

The respective wireless LAN access points ap respectively have two network interfaces. One is a network interface connected to a network cable with the wired LAN router r1. The other one is a network interface on the wireless LAN side. Therefore, the respective wireless LAN access points ap belong to two network segments. One is a network segment sg1 on the wired LAN router r1 side, and the other one is a network segment sg2 or sg3 on the wireless LAN side. In a case where no distinction is made between the respective network segments, the network segments will be referred to as “network segment sg”.

A device having an IP address represented by 192.168.1.x (in CIDR noFtation, 192.168.1.0/24) is connected to the network segment sg1. For example, in the network segment sg1, the wired LAN router r1 has an IP address “192.168.1.1”. The wireless LAN access point ap1 has an IP address “192.168.1.2”. The wireless LAN access point ap2 has an IP address “192.168.1.3”.

A device having an IP address represented by 192.168.2.x (in CIDR notation, 192.168.2.0/24) is connected to the network segment sg2. In the network segment sg2, the wireless LAN access point ap1 has an IP address “192.168.2.1”. The PC 20 has an IP address “192.168.2.2”.

A device having an IP address represented by 192.168.3.x (in CIDR notation, 192.168.3.0/24) is connected to the network segment sg3. In the network segment sg3, the wireless LAN access point ap2 has an IP address “192.168.3.1”. The television set 30 has an IP address “192.168.3.2”.

An IP address of the mobile terminal 10 is decided when the mobile terminal 10 is connected to the network segment sg2 or sg3. For the decision of the IP address, related-art technologies such as DHCP (Dynamic Host Configuration Protocol) may be used. The mobile terminal 10 has an IP address “192.168.2.3” in a state in which the mobile terminal 10 is connected to the network segment sg2. The mobile terminal 10 has an IP address “192.168.3.3” in a state in which the mobile terminal 10 is connected to the network segment sg 3.

The IP addresses of the respective devices in the network system 1 belong to one IP address system. Therefore, an access can be made from a certain device to the other device by specifying an IP address of the other device. Also, the three network segments sg are illustrated, but when the present embodiment is implemented, the number of the network segments sg and a connection method are not limited to a predetermined setting.

Incidentally, in a network having a certain size or larger where a plurality of network segments exist, a setting of the filtering with respect to the multicast is generally carried out with respect to the router. This is because the increase in the network load due to the packet with the destination of the multicast addresses distributed across the network segments may be prevented. According to the present embodiment too, the reaching range of the multicast is limited within one network segment sg. That is, each of the wired LAN router r1, the wireless LAN access point ap1, and the wireless LAN access point ap2 performs the filtering of the packet with the destination of the multicast addresses.

In other words, according to the present embodiment, the “network segment” refers to units of networks sectioned by the devices that perform the filtering of the multicast. The filtering of the multicast refers to no performance of the multicast packet relay or the interruption of the multicast packet distribution.

According to the present embodiment, the mobile terminal 10, the PC 20, the television set 30, and the like correspond to a specification of UPnP (Universal Plug and Play) Device Architecture. The UPnP is a technical specification for connecting personal computers, peripheral devices, AV devices, telephones, house electrical goods, or the like via a network to mutually carry out a functional collaboration. According to the UPnP, the respective devices are classified into a controlled device that provides a function, a control side device that performs a control with respect to the controlled device, or the like. The controlled device is referred to as “UPnP device”. The control side device is referred to as “UPnP control point”. According to the present embodiment, the mobile terminal 10 is the control side device. The PC 20, the television set 30, and the like are the controlled devices.

According to the UPnP, as a method for the control side device to detect (find) the controlled device, as represented by the following (1) and (2), two methods are proposed.

(1) The controlled device sends out data called “Notify with SSDP: alive” by the multicast on a periodic basis. The control side device receives the relevant data and detects the controlled device.

(2) The control side device performs a multicast distribution of data called M-Search. When the relevant data is received, the controlled device replies a response (reply) by the unicast. The control side device receives the response and detects the controlled device.

Also, as a method of detecting the already detected controlled device again, a method represented by the following (3) is proposed.

(3) The control side device transmits the data called M-Search by the unicast. When the relevant data is received, the controlled device replies the response by the unicast. The control side device receives the relevant response and detects the controlled device again. An IP address and a port number of the controlled device which may become necessary for the distribution of the M-Search by the unicast can be obtained from the “Notify with SSDP: alive” data or the response to the M-Search by the multicast.

Therefore, through the above-mentioned method, the mobile terminal 10 which is the control side device can detect the controlled device within the reaching range of the multicast (according to the present embodiment, within the same network segment sg). Furthermore, the mobile terminal 10 can collaborate with the UPnP device by using information included in the data received from the detected controlled device (“Notify with SSDP: alive” or response).

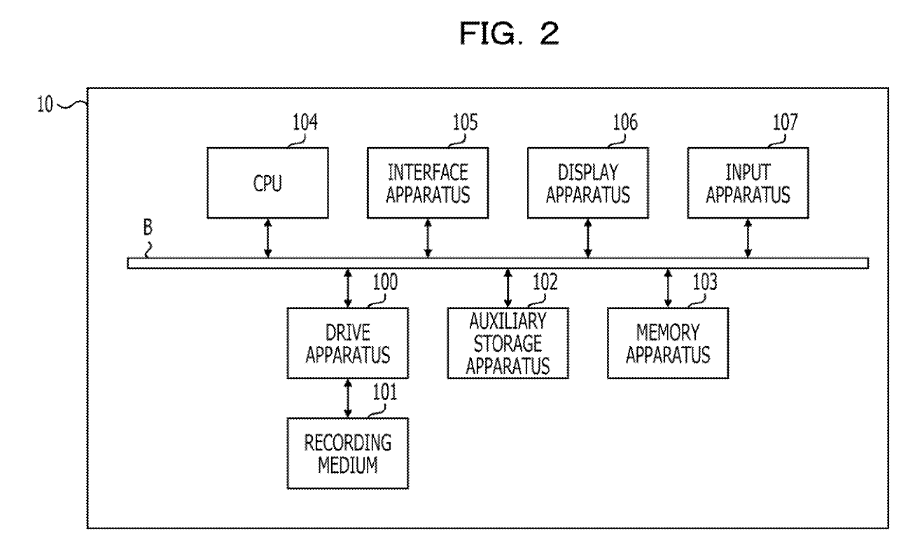

A detail of the mobile terminal 10 will be described. FIG. 2 illustrates a hardware configuration example of the mobile terminal according to an embodiment of the present invention. The mobile terminal 10 of FIG. 2 includes a drive apparatus 100, an auxiliary storage apparatus 102, a memory apparatus 103, a CPU 104, an interface apparatus 105, a display apparatus 106, and an input apparatus 107 which are mutually connected via the bus B.

A program realized through a process in the mobile terminal 10 is provided by a recording medium 101. When the recording medium 101 on which a program is recorded is set in the drive apparatus 100, the program is installed into the auxiliary storage apparatus 102 from the recording medium 101 via the drive apparatus 100. However, the installment of the program is not necessarily carried out by the recording medium 101 and may be downloaded from another computer via the network. The auxiliary storage apparatus 102 stores the installed program and also stores a necessary file, data, and the like.

In a case where an activation instruction of the program is issued, the memory apparatus 103 reads out the program from the auxiliary storage apparatus 102 to be stored. The CPU 104 realizes a function related to the mobile terminal 10 while following the program stored in the memory apparatus 103. The interface apparatus 105 is a part for being connected to the wireless LAN (Local Area Network) such as an antenna. The display apparatus 106 is a liquid crystal panel or the like that displays an operation screen and the like. The input apparatus 107 is a button, a touch panel, a key board, a mouse, or the like.

As an example of the recording medium 101, a portable recording medium is exemplified such as a CD-ROM, a DVD disk, an SD memory card, or a USB memory. Also, the auxiliary storage apparatus 102 may be, for example, an HDD (Hard Disk Drive), a flash memory, or the like. Each of the recording medium 101 and the auxiliary storage apparatus 102 are examples of a computer-readable recording medium.

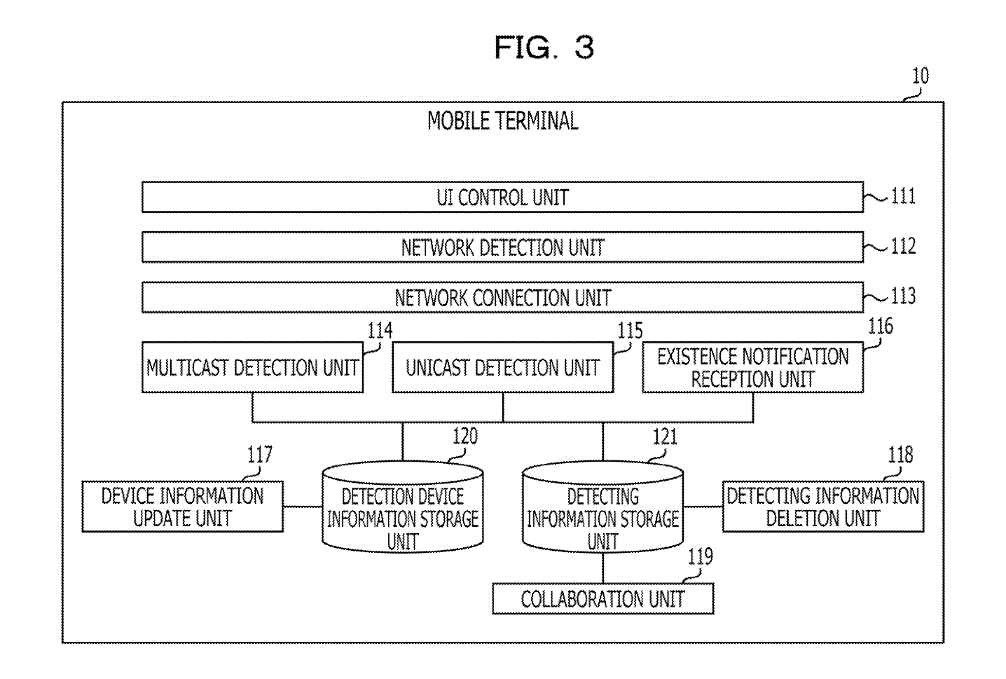

FIG. 3 illustrates a function configuration example of the mobile terminal according to the first embodiment. The mobile terminal 10 has a UI control unit 111, a network detection unit 112, a network connection unit 113, a multicast detection unit 114, a unicast detection unit 115, an existence notification reception unit 116, a device information update unit 117, a detecting information deletion unit 118, a collaboration unit 119, a detection device information storage unit 120, a detecting information storage unit 121, and the like.

The UI control unit 111 performs a display such as an operation screen to the display apparatus 106. The UI control unit 111 also detects an input via the input apparatus 107 and performs a process in accordance with the input. The network detection unit 112 receives signals (packets) called beacons sent out by the wireless LAN access point ap on a periodic basis to detect the existence of the wireless LAN (the wireless LAN access point ap). The network detection unit 112 also extracts identification information of the relevant wireless LAN access point ap from the beacon to be recorded, for example, in the memory apparatus 103. It can be mentioned that identification information of the wireless LAN access point ap is identification information of the network segment sg. Therefore, according to the present embodiment, the relevant identification information is referred to as “segment identification information”. For the segment identification information, for example, SSID (Service Set Identifier), MAC address of the wireless LAN access point ap, or the like may be used.

The network connection unit 113 executes a process for the connection to the wireless LAN which is detected by the network detection unit 112. The multicast detection unit 114 performs a detection of the controlled device by using the multicast. That is, the multicast detection unit 114 sends out M-Search by the multicast (hereinafter, which will be referred to as “multicast M-Search”) to the network. The multicast detection unit 114 detects the controlled device on the basis of the reception of the response to the multicast M-Search. According to the UPnP, the M-Search is data (message) representing a detection request of the device.

The unicast detection unit 115 performs a detection of the controlled device by using the unicast. That is, the unicast detection unit 115 sends out M-Search by the unicast (hereinafter, which will be referred to as “unicast M-Search”) to the network. The unicast detection unit 115 detects the controlled device on the basis of the reception of the response to the unicast M-Search. The unicast detection unit 115 and the mobile terminal 10 transmit the unicast M-Search to the controlled device belonging to different network segment sg from the connected network segment sg. With this configuration, it is possible to realize the collaboration of the devices across the network segments sg.

The existence notification reception unit 116 detects the controlled device on the basis of the reception of the “Notify with SSDP: alive” sent out on a periodic basis by the controlled device to notify of its own existence.

The detection device information storage unit 120 stores device information related to the controlled device detected (found) by the multicast detection unit 114, the unicast detection unit 115, or the existence notification reception unit 116 (hereinafter, which will be referred to as “device information”) by using, for example, the volatile memory apparatus 103. Device information is information included in the response to the M-Search or “Notify with SSDP: alive”. According to the present embodiment, the detection device information storage unit 120 may be an example of a second storage unit.

The detecting information storage unit 121 stores the information for the unicast detection unit 115 to detect the controlled device belonging to the different network segment sg (hereinafter, which will be referred to as “detecting information”) by using, for example, the non-volatile auxiliary storage apparatus 102. However, in the case of the mobile terminal 10 moved while a power supply is in an ON state, the detecting information may be stored in the memory apparatus 103. That is, the detecting information is recorded in the non-volatile auxiliary storage apparatus 102 because the detecting information is not to be lost in a case where the power supply of the mobile terminal 10 is cut off while the mobile terminal 10 is moved. A part of the detecting information is extracted from the information at the transmission source of the response to the multicast M-Search or “Notify with SSDP: alive”. Also, the detecting information also includes the segment identification information obtained by the network detection unit 112 and recorded in the memory apparatus 103. According to the present embodiment, the detecting information storage unit 121 is an example of a first storage unit.

The device information update unit 117 deletes invalid device information from the detection device information storage unit 120. The invalid device information is, for example, device information corresponding to the controlled device which does not receive the “Notify with SSDP: alive” within a predetermined period of time. To be more specific, the device information includes information indicating a timeout time. The device information update unit 117 does not receive the “Notify with SSDP: alive” from the corresponding controlled device within the timeout time for the device information, the relevant device information is deleted. According to the present embodiment, the device information update unit 117 is an example of a deletion unit.

The detecting information deletion unit 118 deletes a part or all of the detecting information from the detecting information storage unit 121 at a predetermined timing.

The collaboration unit 119 performs a control on the detected device (collaboration with the detected device) by using the device information stored in the detection device information storage unit 120.

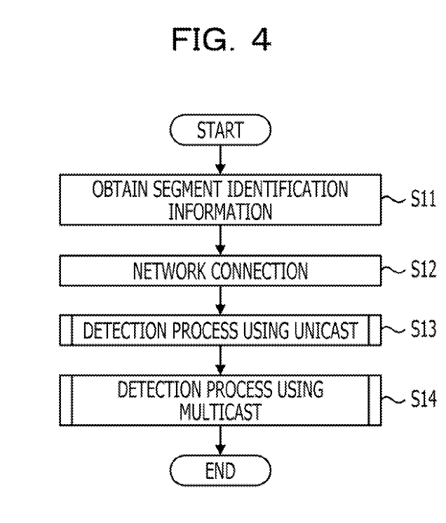

Hereinafter, a process procedure executed by the mobile terminal 10 will be described. FIG. 4 is a flow chart for describing an example of a process procedure executed by the mobile terminal according to the first embodiment.

In step S11, the network detection unit 112 detects the wireless LAN access point ap (the wireless LAN) to which the mobile terminal 10 can be currently connected and obtains the segment identification information from the detected wireless LAN access point ap. The detection of the wireless LAN is carried out, for example, on the basis of the reception of the beacon sent out by the wireless LAN access point ap. Also, the segment identification information is extracted, for example, from the beacon. The network detection unit 112 records the obtained segment identification information in the memory apparatus 103.

Subsequently, the network connection unit 113 connects to the wireless LAN (the wireless LAN access point ap) detected by the network detection unit 112 (S12). For example, the network connection unit 113 displays a list of SSID included in the beacon on the display apparatus 106. The network connection unit 113 is connected to the wireless LAN access point ap related to the SSID selected by the user. Alternatively, the SSID where the connection is permitted may be previously recorded the auxiliary storage apparatus 102. In this case, the network connection unit 113 is connected to the wireless LAN access point ap related to the previously recorded SSID among the wireless LAN access points ap where the connection can be carried out. At the time of the connection to the wireless LAN, an authentication may be carried out while authentication information is input. According to the present embodiment, a method for the connection to the wireless LAN is not limited to a predetermined method.

When being connected to the wireless LAN, the unicast detection unit 115 performs the detection process of the controlled device by using the unicast (S13). Subsequently, the multicast detection unit 114 performs the detection process of the controlled device by using the multicast (S14).

The order of steps S13 and S14 may be reversed.

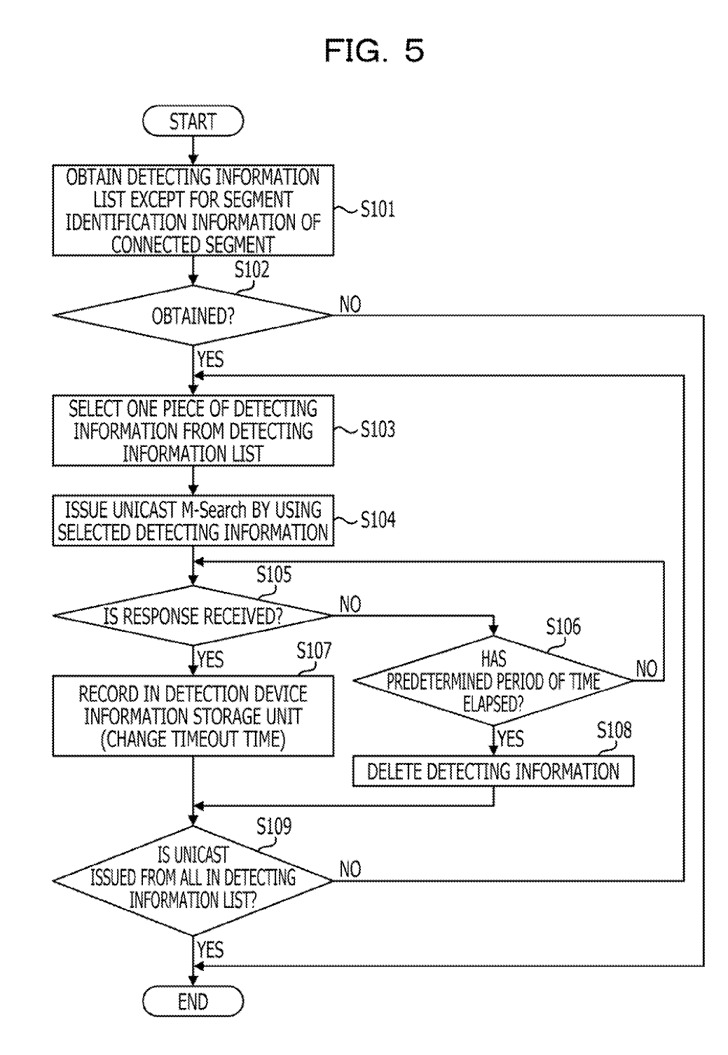

Subsequently, a detail of step S13 will be described. FIG. 5 is a flow chart for describing an example of a process procedure of a detection process for a controlled device using unicast.

In step S101, the unicast detection unit 115 obtains the detecting information from the detecting information storage unit 121.

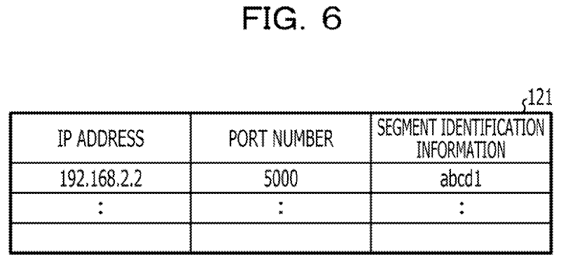

FIG. 6 illustrates a configuration example of the detecting information storage unit. The detecting information storage unit 121 stores the detecting information for each of the controlled devices previously detected by the multicast detection unit 114. The detecting information includes the IP address, the port number, the segment identification information, and the like. The controlled device previously detected by the multicast detection unit 114 refers to the controlled device detected in step S14 which was executed in the past.

The IP address and the port number are an IP address and a port number of the controlled device. According to the present embodiment, The IP address and the port number are examples of address information of the device. The segment identification information is the segment identification information of the network segment sg to which the mobile terminal 10 is connected when the controlled device is detected by the multicast detection unit 114. In the mobile terminal 10, in a case where the detection of the controlled device by the multicast detection unit 114 is not carried out even once, the content of the detecting information storage unit 121 is empty.

In step S101, the detecting information is obtained by the detecting information storage unit 121 described above. The obtained detecting information is the detecting information related to the segment identification information except for the segment identification information of the network segment sg where the mobile terminal 10 is currently connected. The segment identification information of the network segment sg where the mobile terminal 10 is currently connected refers to the segment identification information obtained by the network detection unit 112 in step S11 and recorded in the memory apparatus 103. However the timing when the segment identification information is obtained is not necessarily limited to step S11. For example, the obtainment of the segment identification information may be carried out substantially immediately before step S101. A point in which the segment identification information of the currently connected network segment sg is obtained by the network detection unit 112 and may not be the segment identification information recorded in the memory apparatus 103 applies similarly in the following description.

Since the obtained detecting information is limited as described above, it is possible to substantially suppress the unnecessary increase in the communication amount by the unicast. This is because the controlled device belonging to the network segment sg where the mobile terminal 10 is currently connected can be detected by the multicast detection unit 114.

Subsequently, the unicast detection unit 115 determines whether or not at least one piece of the detecting information is obtained (S102). In a case where none of the detecting information is obtained (S102: No), the process in FIG. 5 is ended.

On the other hand, in a case where one or more pieces of the detecting information is obtained (S102: Yes), the unicast detection unit 115 selects one piece of the detecting information which is set as a process target (hereinafter, which will be referred to as “target detecting information”) among the list of the obtained detecting information (S103). Subsequently, the unicast detection unit 115 transmits the unicast M-Search addressed to the IP address and the port number included in the target detecting information (S104). Since the unicast M-Search is the unicast, if it is within the network system 1 that forms one IP address system, the unicast M-Search can reach addresses across the network segments sg.

The controlled device that has received the unicast M-Search replies a response to the transmission source of the unicast M-Search.

Subsequently, the unicast detection unit 115 stands by for the reception of the response to the unicast M-Search (S105, S106). In a case where the response is received in a predetermined period of time (S105: Yes), the unicast detection unit 115 records the device information included in the received response to the detection device information storage unit 120 in an adding manner (S107).

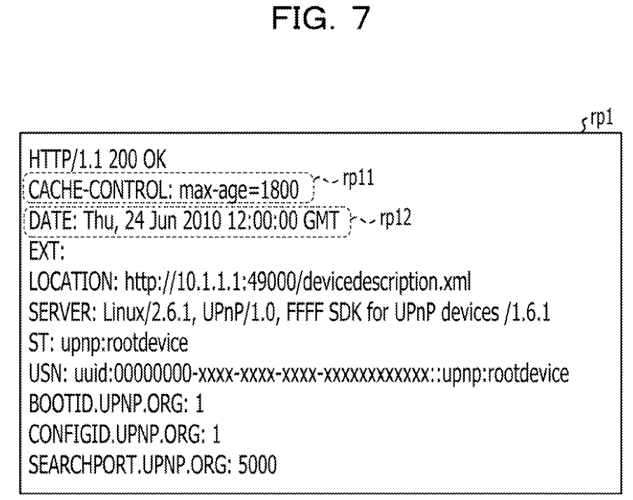

FIG. 7 illustrates an example of a response to unicast M-Search. A format of a response rp1 illustrated is one regulated according to the UPnP, and therefore a detailed description will be omitted. Herein, descriptions rp11 and rp12 will be described. The description rp11 includes a value of CACHE-CONTROL (“1800”). CACHE-CONTROL is the timeout time, and the unit of the value is a second. Therefore, the description rp11 indicates that the timeout time is 1800 seconds. The description rp12 includes the value of DATE. The value of DATE is response transmission date and hour and is set as a reference of the timeout time. That is, the date and hour when the timeout time elapses from the date and hour specified by DATE becomes a time limit of the timeout (validity time limit).

Herein, the timeout time refers to the timeout time related to the cache of the device information based on the response rp1. According to the present embodiment, the device information is cached in the detection device information storage unit 120. Therefore, the timeout time refers to a time for holding the device information in the detection device information storage unit 120.

In general, in a case where the state becomes the unusable state because of the power supply OFF or the like, the controlled device performs the multicast of an SSDP: byebye message. When the SSDP: byebye message is received, the control side device deletes the device information of the controlled device at the transmission source of the relevant message from the detection device information storage unit 120. As a result, the storage target of the detection device information storage unit 120 can be limited to the device information of the controlled device having a high probability of being currently usable. However, like a case of an abnormal end or the like, the controlled device may be in the unusable state in some cases because the multicast transmission of the SSDP: byebye message is not carried out. By taking into account the above-mentioned case, the response rp1 includes the timeout time. That is, in the detection device information storage unit 120, the device information update unit 117 automatically deletes the device information in which the time limit of the timeout arrives. The controlled device in the usable state multicasts the “Notify with SSDP: alive” within the timeout time. The time limit of the timeout is updated by the information included in the “Notify with SSDP: alive”.

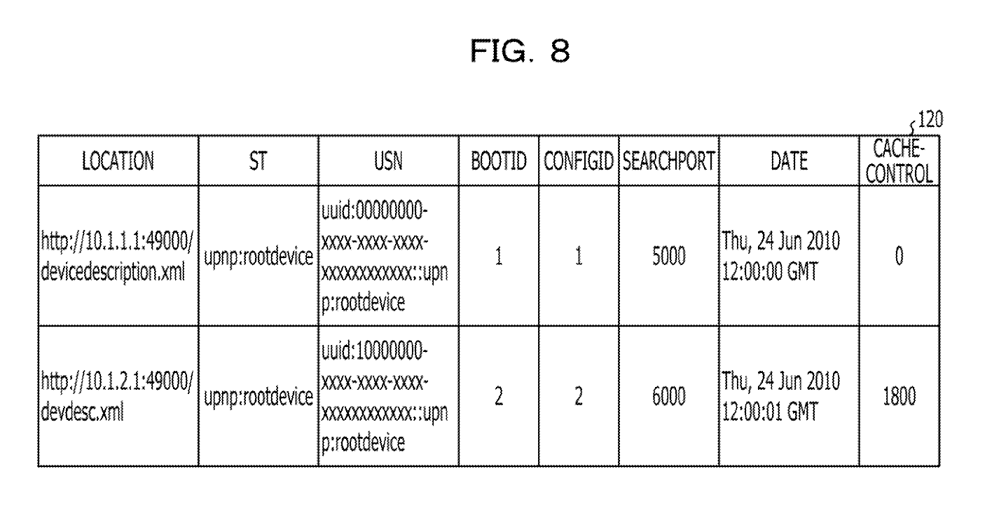

Also, FIG. 8 illustrates a configuration example of the detection device information storage unit. The detection device information storage unit 120 stores the device information for each of the detected devices. The content of the device information is basically transferred from the response. For example, the device information in line 1 corresponds to the response rp1 in FIG. 7.

The unicast detection unit 115 invalidates the timeout time (CACHE-CONTROL). To be more specific, the timeout time is not a value included in the response, but a value representing an indefinite period (for example, “0”) is recorded. As described above, in general, the controlled device multicasts the “Notify with SSDP: alive” within the timeout time. However, the controlled device detected by the unicast detection unit 115 belongs to the network segment sg to which the mobile terminal 10 is connected and the different network segment sg. Therefore, the “Notify with SSDP: alive” multicast by the relevant controlled device is subjected to the filtering by the wireless LAN access point ap or the wired LAN router r1 in mid-course and does not reach the mobile terminal 10. As a result, in accordance with the arrival of the time limit of the timeout, the relevant device information of the controlled device is automatically deleted by the device information update unit 117 from the detection device information storage unit 120. In that case, for example, during the collaboration with the relevant controlled device, the relevant device information of the controlled device is lost, and the mobile terminal 10 may not be able to continue the collaboration.

To avoid the above-mentioned inconvenience, the timeout time for the device information of the controlled device detected by the unicast detection unit 115 is operated into the value representing the indefinite period. A method of invalidating the validity time limit for the device information is not limited to the operation on the value of the timeout time. For example, flag information or the like indicating a prohibition of the automatic deletion may be added to the device information and recoded in the detection device information storage unit 120. In this case, on the basis of the relevant flag information, the device information update unit 117 determines whether or not the automatic deletion is permitted in accordance with the arrival of the time limit of the timeout.

Alternatively, with regard to the controlled device detected by the unicast M-Search, before the time limit of the timeout, the unicast detection unit 115 may issue the unicast M-Search again, and the timeout time may be updated on the basis of the response. In this case, for each piece of the device information, the flag information indicating whether or not it is detected by the unicast M-Search may be recorded in the detection device information storage unit 120.

Subsequently, the unicast detection unit 115 determines whether or not the process in FIG. 5 is executed with regard to all the detecting information obtained in step S101 (S109). In a case where the unprocessed detecting information remains (S109: No), with regard to the unprocessed detecting information, the unicast detection unit 115 repeatedly performs step S103 and subsequent steps. In a case where the unprocessed detecting information does not exist (S109: Yes), the process in FIG. 5 is ended.

On the other hand, in a case where the response is not received even when the stand by for the response in steps S105 and S106 continues for a predetermined period of time (S106: Yes), the detecting information deletion unit 118 deletes the target detecting information from the detecting information storage unit 121 (S108). That is, in a case where the number of the controlled devices connected to the network system 1 becomes large, a large number of pieces of the detecting information may be recorded in the detecting information storage unit 121. In that case, for example, it the user is asked to select the collaboration target among the list of the detecting information, the selection may be difficult since the number of the selection candidates is too large. By deleting, from the detecting information, the device information of the controlled device that is detected through the unicast M-Search, the selection candidates can be reduced.

In FIG. 5, the process is represented as a serial process for each of the detecting information, but the process may be executed in parallel with regard to plural pieces of the detecting information.

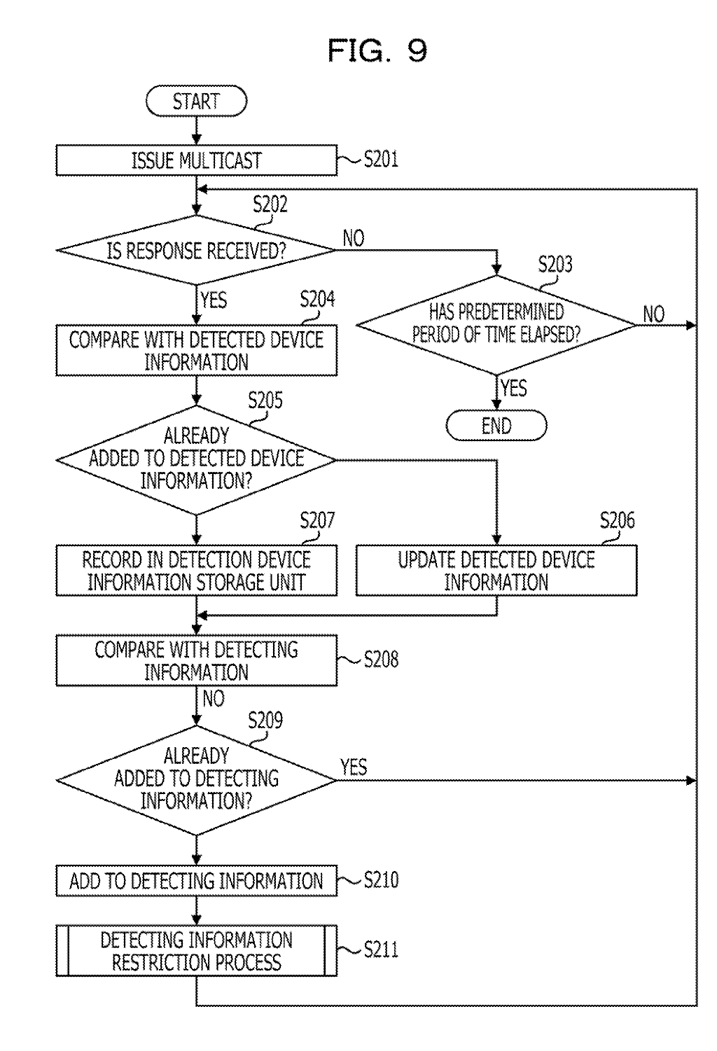

Subsequently, a detail of step S14 in FIG. 4 will be described. FIG. 9 is a flow chart for describing an example of a process procedure of a detection process for a controlled device using multicast.

In step S201, the multicast detection unit 114 distributes the multicast M-Search via the currently connected wireless LAN access point ap. Subsequently, the multicast detection unit 114 stands by for the reception of the response to the multicast M-Search (S202, S203).

When the response is received, the multicast detection unit 114 compares the device information included in the received response with the device information recorded in the detection device information storage unit 120 (S204). A format of the response to the multicast M-Search is similar to FIG. 7. In a case where the device information related to the controlled device which is the same as the device information included in the response is recorded in the detection device information storage unit 120 (S205: Yes), the multicast detection unit 114 updates the device information of the detection device information storage unit 120 by the detection device by the device information in the response (S206). For example, the value of DATE or the like is updated.

On the other hand, in a case where the device information related to the controlled device which is the same as the device information included in the response is not recorded in the detection device information storage unit 120 (S205: No), the multicast detection unit 114 records the device information included in the response in the detection device information storage unit 120 in the adding manner (S207).

Following step S206 or S207, the multicast detection unit 114 compares the IP address and the port number at the transmission source of the response with the IP address and the port number recorded in the detecting information storage unit 121 (S208). In a case where the detecting information including values matched with the IP address and the port number at the transmission source of the response is not recorded in the detecting information storage unit 121 (S209: No), the multicast detection unit 114 records the detecting information at the transmission source of the response in the detecting information storage unit 121 in the adding manner (S210). That is, the detecting information including the IP address and the port number at the transmission source of the response and also including the segment identification information of the currently connected network segment sg is added to the detecting information storage unit 121.

Subsequently, the detecting information deletion unit 118 executes a process for restricting the number of recordings of the detecting information in the detecting information storage unit 121 (detecting information restriction process) (S211).

In the case of Yes in step S209 or following step S211, step S202 and subsequent steps are repeatedly carried out. This is because, in the case of the multicast M-Search, the responses may be received from the plurality of controlled devices. In a case where the response is not received continuously for a predetermined period of time or longer (S203: Yes), the multicast detection unit 114 ends the process of FIG. 9.

The collaboration unit 119 of the mobile terminal 10 performs the collaboration with the controlled device by using recorded in the detection device information storage unit 120 through the process in FIG. 4 to FIG. 9. For example, the collaboration target is selected by the user among the controlled devices where the device information is stored in the detection device information storage unit 120. The collaboration unit 119 causes the selected controlled device and the mobile terminal 10 to perform the collaboration.

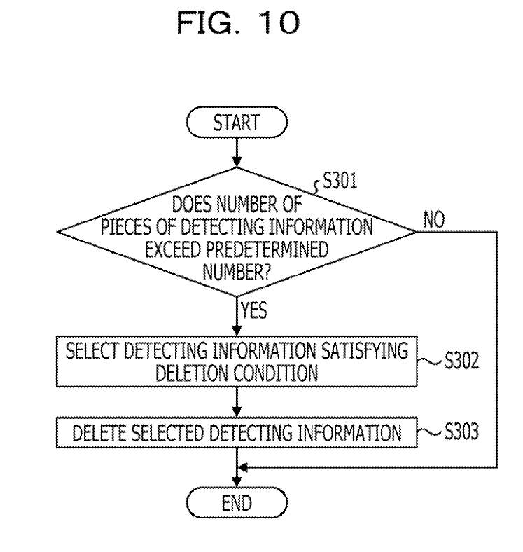

Subsequently, a detail of step S211 in FIG. 9 will be described. FIG. 10 is a flow chart for describing an example of a process procedure of a detecting information control process.

In step S301, the detecting information deletion unit 118 determines whether or not the number of pieces of the detecting information recorded in the detecting information storage unit 121 exceeds a predetermined number. The predetermined number may be appropriately decided on the basis of a storage capacity or the like that the detecting information storage unit 121 can use. In a case where the number of pieces of the detecting information is smaller than or equal to the predetermined number (S301: No), the detecting information deletion unit 118 ends the process of FIG. 10.

In a case where the number of pieces of the detecting information exceeds the predetermined number (S301: Yes), the detecting information satisfying a deletion condition is selected as a deletion target (S302). For the deletion condition, for example, a condition related to the number of collaborations with the controlled device corresponding to the respective pieces of detecting information, a condition related to a time of the last collaboration, and the like may be examples.

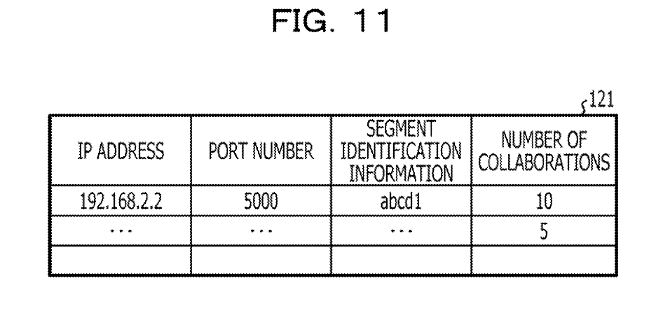

To be more specific, the condition related to the number of collaborations is a condition in which the detecting information related to the controlled device having the smallest number of collaborations is selected. In this case, the detecting information storage unit 121 may be extended, for example, as illustrated in FIG. 11.

FIG. 11 illustrates a first extended example of the detecting information storage unit. The detecting information storage unit 121 can store the number of collaborations for each of the controlled devices. For example, when the controlled device of the collaboration target is selected, the collaboration unit 119 increments the number of collaborations in the detecting information corresponding to the relevant controlled device.

If the detecting information having the smallest number of collaborations is regularly selected as the deletion target, the detecting information for the newly detected controlled device is regularly deleted. In that case, substantially, the detecting information for the newly detected controlled device is recorded in the detecting information storage unit 121. In view of the above, a time when the detecting information is recorded may also be recorded in the detecting information storage unit 121. The detecting information having the nearest record time may be excluded from the deletion target even if the number of collaborations is smallest.

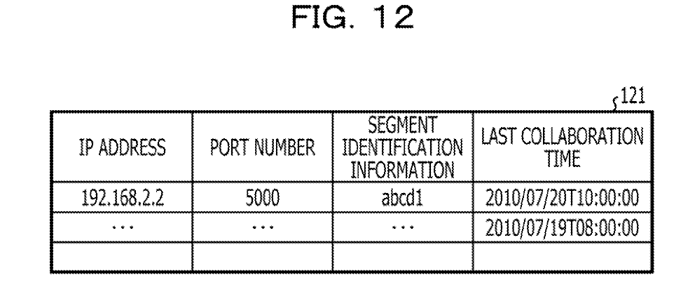

Also, the condition related to the time of the last collaboration is a condition in which the detecting information related to the controlled device having the oldest time when the last collaboration is carried out is selected. In this case, the detecting information storage unit 121 may be extended, for example, as illustrated in FIG. 12.

FIG. 12 illustrates a second extended example of the detecting information storage unit. The detecting information storage unit 121 can store the last collaboration time for each of the controlled devices. For example, when the controlled device of the collaboration target is selected, the collaboration unit 119 records the current time in the last collaboration time of the detecting information corresponding to the relevant controlled device.

Subsequently, the detecting information deletion unit 118 deletes the selected detecting information from the detecting information storage unit 121 (S303).

The process contents described in FIG. 4 to FIG. 9 will be described while being applied to a specific situation. As an initial state of the relevant specific situation, the content of the detecting information storage unit 121 of the mobile terminal 10 is set to be empty.

First, when the process in FIG. 4 to FIG. 9 is executed while the mobile terminal 10 is within the range of the radio waves of the wireless LAN access point ap1 (see FIG. 1), the multicast detection unit 114 detects the PC 20. Therefore, the detecting information for the PC 20 is recorded in the detecting information storage unit 121, and the device information of the PC 20 is recorded in the detection device information storage unit 120. The detection of the controlled device by the unicast detection unit 115 is not carried out. In the initial state, the detecting information does not exist.

Subsequently, it is assumed that the mobile terminal 10 is moved into the range of the radio waves of the wireless LAN access point apt and the process in FIG. 4 to FIG. 9 is executed. In this case, the unicast detection unit 115 detects the PC 20. Also, the multicast detection unit 114 detects the television set 30. Therefore, the detecting information of the television set 30 is added to the detecting information storage unit 121, and the device information of the television set 30 is added to the detection device information storage unit 120. As a result, the collaboration unit 119 can collaborate with not only the television set 30 belonging to the same network segment sg3 as the mobile terminal 10 but also the PC 20 belonging to the network segment sg2 as different from the mobile terminal 10.

As a result, for example, when the mobile terminal 10 is connected to the network segment sg3, it becomes possible to take out the content data saved in the PC 20 to be displayed on the television set 30.

In a case where the mobile terminal 10 is connected to the network segment sg3 again later, when the unicast detection unit 115 executes the process in FIG. 5, the detecting information of each of the PC 20 and the television set 30 is recorded in the detecting information storage unit 121. However, the unicast M-Search is not transmitted to the television set 30. This is because the segment identification information of the network segment sg3 where the mobile terminal 10 is currently connected (the wireless LAN access point apt) is recorded in the detecting information of the television set 30.

In step S11, in a case where the plurality of wireless LAN access points ap (the plurality of wireless LANs) are detected, for each of the wireless LAN access points ap, steps S12 to S14 may be repeatedly carried out. In a case where steps S12 to S14 are repeatedly carried out, in step S12, the network connection unit 113 cuts off the connection with the wireless LAN that has been connected so far and performs the connection process for the next wireless LAN.

With this configuration, it is possible to avoid an inconvenience caused in a case where the mobile terminal 10 is arranged in a location where the plurality of connectable wireless LAN access points ap exist. That is, it is possible to avoid the generation of the situation in which the mobile terminal 10 detects or does not detect the controlled device desired to be collaborated depending on which one of the wireless LAN access points ap the mobile terminal 10 is connected to.

As described above, according to the first embodiment, it is possible to appropriately realize the detection, the collaboration, and the like of the controlled device beyond the network segment sg. In other words, it is possible to avoid the situation in which the detection range of the controlled device is limited by the network segment sg.

Also, when the present embodiment is implemented, the controlled device, the network, and the like do not need to be mounted with a special function. Also, with regard to the mobile terminal 10, the function for realizing the present embodiment is realized by installing the program for executing the process procedure illustrated in FIG. 4 to FIG. 10 into the mobile terminal 10. In other words, with regard to the mobile terminal 10, no special hardware is required for realizing the present embodiment. Therefore, according to the present embodiment, it is possible to realize the detection, the collaboration, and the like of the controlled device beyond the network segment sg at a low cost.

It is also conceivable that the detection and the like of the controlled device beyond the network segment sg can be carried out while the multicast M-Search is not filtered by the router or the like. However, according to the present embodiment, as compared with the case in which the multicast M-Search is not filtered by the router or the like, it is possible to reduce the communication amount in the network as follows.

For example, it is assumed that 1000 controlled devices are connected to the network system 1. In this case, if the filtering of the multicast is not carried out, the multicast M-Search from the mobile terminal 10 is distributed to all the network segments sg. In that case, even when the data amount of the M-Search is approximately 1 k bytes, the data of 1 k×1000=1 M bytes is circulated into the entire network system 1. In a case where the plurality of mobile terminals 10 exist, the circulated data amount is increased in accordance with the number of the mobile terminals 10.

On the other hand, in a case where the filtering of the multicast is carried out, the distribution range of the multicast M-Search is limited to one network segment sg. For example, it is assumed that the network system 1 is divided into ten network segments sg, and 100 controlled devices are connected to the respective network segments sg. Also, it is assumed that the detecting information storage unit 121 stores ten pieces of the detecting information of the other network segments sg. In this case, the circulated data amount of the distribution of the unicast M-Search and the multicast M-Search becomes 1 k×10+1 k×100=110 k bytes.

Therefore, according to the present embodiment, in particular, in the large-sized network, it is possible to realize the detection, the collaboration, and the like of the controlled device beyond the network segment sg while the increase of the network communication amount is substantially suppressed.

Next, a second embodiment will be described. According to the second embodiment, a description will be mainly given of a different point from the first embodiment. Therefore, according to the second embodiment, a point that is not particularly mentioned may be similar to the first embodiment.

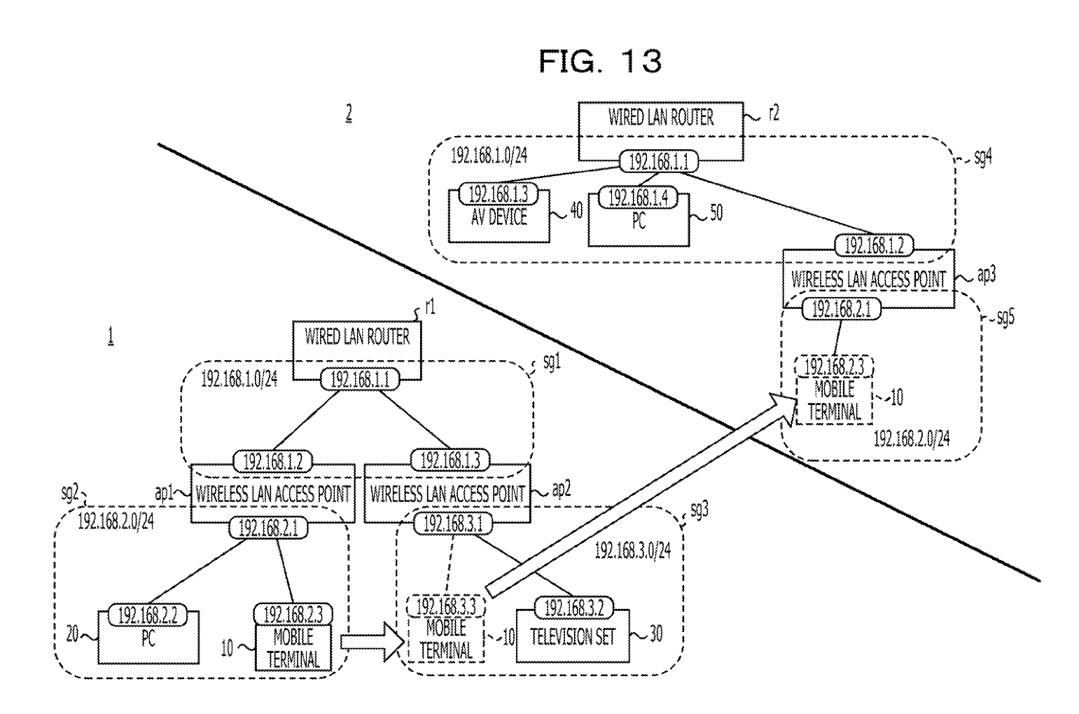

FIG. 13 illustrates a network configuration example according to the second embodiment. In FIG. 13, the same reference symbol is assigned to the substantially same part as illustrated in FIG. 1, and a description thereof will be omitted.

According to the second embodiment, the existence of a network system 2 is also taken into account. For example, it may be supposed that the network system 1 is an office network environment for the user of the mobile terminal 10, and the network system 2 is a house network environment for the relevant user.

In the network system 2, a wired LAN router r2 is connected to each of a wireless LAN access point ap3, an AV device 40, and a PC 50 via a LAN cable.

The wireless LAN access point ap3 has two network interfaces. One is a network interface connected to a network cable with the wired LAN router r2. The other one is a network interface on the wireless LAN side. Therefore, the wireless LAN access point ap3 belongs to two network segments. One is a network segment sg4 on the wired LAN router r2 side, and other one is a network segment sg5 on the wireless LAN side.

Devices having an IP address represented by 192.168.1.x (in CIDR notation, 192.168.1.0/24) are connected to the network segment sg4. For example, in the network segment sg4, the wired LAN router r2 has an IP address “192.168.1.1”. The wireless LAN access point ap3 has an IP address “192.168.1.2”. The AV device 40 has an IP address “192.168.1.3”. The PC 50 has an IP address “192.168.1.4”.

Devices having an IP address represented by 192.168.2.x (in CIDR notation, 192.168.2.0/24) are connected to the network segment sg5. In the network segment sg5, the wireless LAN access point ap3 has an IP address “192.168.2.1”. In a case where the mobile terminal 10 is connected to the network segment sg5, an IP address of the mobile terminal 10 is, for example, “192.168.2.2”.

The network system 2 has an IP address system different from the network system 1. Therefore, the device in the network system 1 and the device in the network system 2 do not directly communication with each other. Also, as illustrated, the same IP address may be allocated between the network system 1 and the network system 2 in some cases.

According to the second embodiment, a case is taken into account in which the mobile terminal 10 is used in both the network systems 1 and 2.

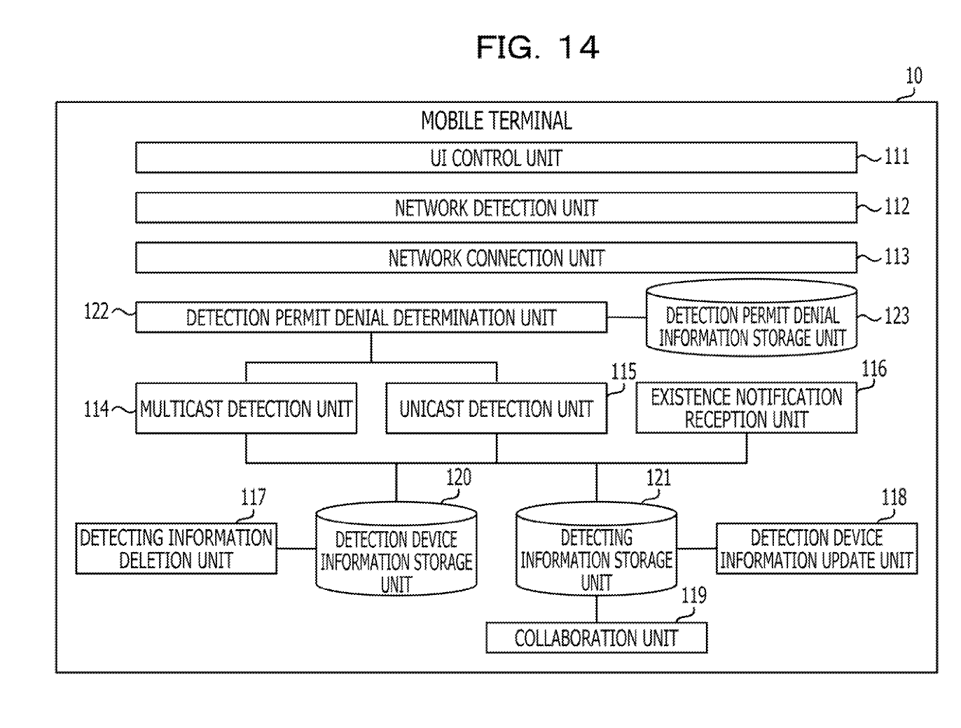

FIG. 14 illustrates a function configuration example of a mobile terminal according to the second embodiment. In FIG. 14, the same reference symbol is assigned to the substantially same part as illustrated in FIG. 3, and a description thereof will be omitted.

In FIG. 14, a detection permit denial determination unit 122 and a detection permit denial information storage unit 123 are added with respect to FIG. 3. The detection permit denial information storage unit 123 stores information indicating permit or denial for the execution of the detection process of the controlled device (hereinafter, which will be referred to as “detection permit denial information”) for each of the network segments sg by using, for example, the auxiliary storage apparatus 102. The detection permit denial determination unit 122 performs a registration of the detection permit denial information into the detection permit denial information storage unit 123, a determination as to the permit or denial for the execution of the detection process based on the detection permit denial information, and the like. The detection process refers to a process in steps S13 and S14 in FIG. 4. Also, according to the present embodiment, the detection permit denial determination unit 122 is an example of a determination unit. The detection permit denial information storage unit 123 is an example of a permit denial information storage unit.

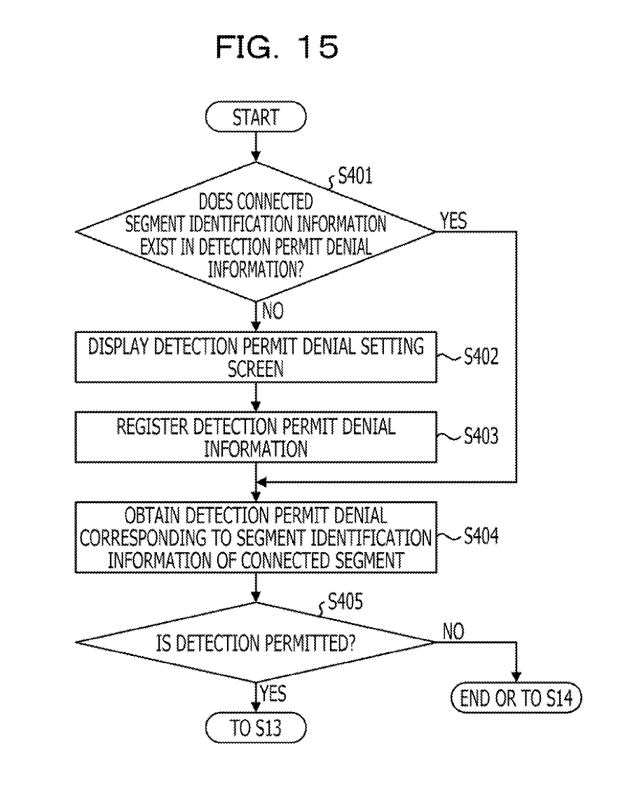

According to the second embodiment, a process procedure illustrated in FIG. 15 is added between step S12 and step S13 in FIG. 4.

FIG. 15 is a flow chart for describing an example of a process procedure added according to the second embodiment.

In step S401, the detection permit denial determination unit 122 determines whether or not the detection permit denial information related to the segment identification information of the network segment sg where the mobile terminal 10 is currently connected is recoded in the detection permit denial information storage unit 123.

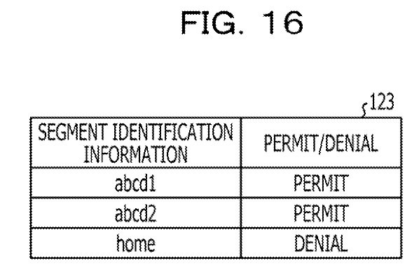

FIG. 16 illustrates a configuration example of a detection permit denial information storage unit. The detection permit denial information storage unit 123 stores the segment identification information and the permit or denial for each of the network segments sg. The permit or denial is an item indicating the permit or denial for the execution of the detection process with regard to the network segment sg identified by the segment identification information. “Permit” indicates the permit for the execution of the detection process. “Denial” indicates the denial for the execution of the detection process. The content of the detection permit denial information storage unit 123 is registered in step S403 which will be described below. Therefore, in the mobile terminal 10, in a case where step S403 is not executed even once, the content of the detection permit denial information storage unit 123 is empty. However, at an asynchronous timing from the process of FIG. 15, the content of the detection permit denial information storage unit 123 may be registered in advance.

In a case where the detection permit denial information related to the segment identification information of the currently connected network segment sg is not recorded in the detection permit denial information storage unit 123 (S401: No), the detection permit denial determination unit 122 displays a detection permit denial setting screen on the display apparatus 106 (S402). The detection permit denial setting screen refers to a screen for querying about the permit or denial for the execution of the detection process in the currently connected network segment sg.

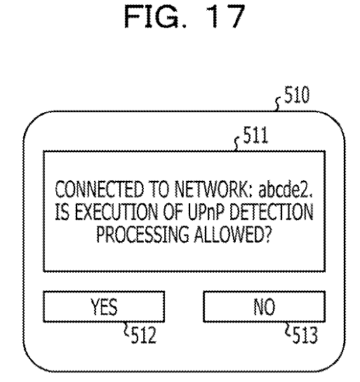

FIG. 17 illustrates a display example of a detection permit denial setting screen. The detection permit denial setting screen 510 includes a message 511, a Yes button 512, the No button 513, and the like.

The message 511 is a query about the permit or denial for the execution of the detection process in the currently connected network segment sg. The Yes button 512 is a button for accepting an input of the permit for the execution of the detection process. The No button 513 is a button for accepting an input of the denial for the execution of the detection process.

In the detection permit denial setting screen 510, when the Yes button 512 or the No button 513 is pressed, the detection permit denial determination unit 122 registers (records) the detection permit denial information in accordance with the pressed button in the detection permit denial information storage unit 123 (S403). That is, in a case where the Yes button 512 is pressed, the detection permit denial determination unit 122 registers the detection permit denial information including the segment identification information of the currently connected network segment sg and “permit” in the detection permit denial information storage unit 123. In a case where the No button 513 is pressed, the detection permit denial determination unit 122 registers the detection permit denial information including the segment identification information of the currently connected network segment sg and “denial” in the detection permit denial information storage unit 123.

Following step S403 or the case of Yes in step S401, the detection permit denial determination unit 122 obtains the detection permit denial information related to the segment identification information of the currently connected network segment sg from the detection permit denial information storage unit 123 (S404). Subsequently, the detection permit denial determination unit 122 determines the permit or denial for the execution of the detection process on the basis of the obtained detection permit denial information (S405). That is, in a case where the value of the permit or denial of the relevant detection permit denial information is “permit” (S405: Yes), the detection permit denial determination unit 122 determines that the execution of the detection process is permitted and permits the continuation of the process in step S13 and subsequent steps in FIG. 4. On the other hand, in a case where the value of the permit or denial of the relevant detection permit denial information is “denial” (S405: No), the detection permit denial determination unit 122 determines that the execution of the detection process is denied and cancels the execution of the process in step S13 and subsequent steps.

In a case where the value of the permit or denial of the relevant detection permit denial information is “denial”, the range of the cancellation of the detection process may be limited to the detection process by the unicast (step S13). In other words, the detection process by the multicast (step S14) may be executed. In this case, it is suitably configured that the recording of the detecting information to the detecting information storage unit 121 is not carried out. If the detecting information is recorded, when the detection process is executed in the other network segment sg, the unicast M-Search based on the relevant detecting information is transmitted. The unicast M-Search includes an IP address of the destination, a port number, information on a service desired to be set as a collaboration target, and the like. This is because, with regard to the controlled device where the detection by the unicast is denied, it is not suitable in terms of security that the IP address, the port number, the information on the service, and the like are circulated in the other network segment sg (for example, the network segment sg in public).

According to the present embodiment, for example, with regard to the network segment sg belonging to the network system 2, it is conceivable to set that the execution of the detection process of the unicast M-Search is not permitted. In this case, the unicast M-Search addressed to the IP address and the port number of the controlled device in the office can be substantially prevented from being transmitted in the house. Also, in a case where the network system 2 is used in a public place, the unicast M-Search addressed to the IP address and the port number of the controlled device in the office can be substantially prevented from being transmitted on the public network.

As described above, according to the second embodiment, the network environment where the unicast M-Search is transmitted can be restricted on the basis of a will of the user. As a result, for example, in a case where the filtering of the multicast is not carried out like the network in the house, it is possible to substantially suppress the transmission of the unicast M-Search. Also, it is possible to reduce a probability of a degradation in the security or the like which is caused by the random transmission of the unicast M-Search.

Next, a third embodiment will be described. According to the third embodiment, a description will be mainly given of a different point from the first embodiment. Therefore, According to the third embodiment, a point that is not particularly mentioned may be substantially similar to the first embodiment.

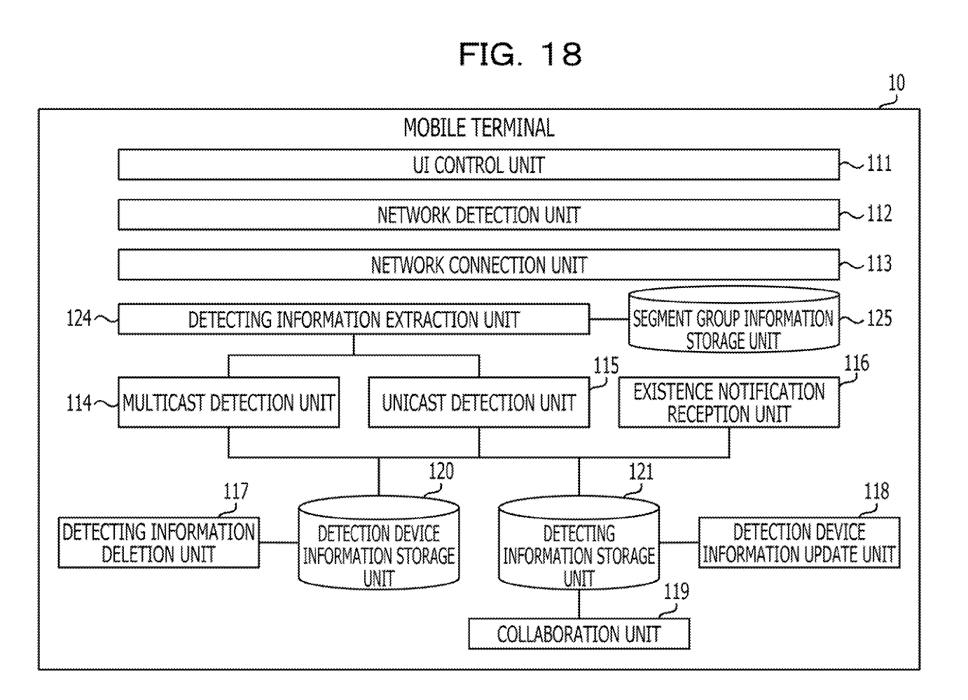

FIG. 18 illustrates a function configuration example of a mobile terminal according to the third embodiment. In FIG. 18, the same reference symbol is assigned to the substantially same part as illustrated in FIG. 3, and a description thereof will be omitted.

In FIG. 18, a detecting information extraction unit 124 and a segment group information storage unit 125 are added with respect to FIG. 3.

The segment group information storage unit 125 stores information (hereinafter, which will be referred to as “segment group information”) indicating groups for classifying the network segment sg (hereinafter, which will be referred to as “segment group”) for each piece of the segment identification information by using, for example, the auxiliary storage apparatus 102. The detecting information extraction unit 124 limits the detecting information used for the unicast M-Search on the basis of the segment identification information of the currently connected network segment sg and the segment group information. To be more specific, the detecting information extraction unit 124 extracts the detecting information related to the network segment sg belonging to the segment group that is the same as the currently connected network segment sg from the detecting information storage unit 121. The detecting information extraction unit 124 also executes a registration of the segment group information to the segment group information storage unit 125. According to the present embodiment, the segment group information storage unit 125 is an example of a group information storage unit. The detecting information extraction unit 124 is an example of an extraction unit.

According to the third embodiment, similarly as in the second embodiment, the network structure illustrated in FIG. 13 is taken into account. That is, the existence of a plurality of network systems having mutually different IP address systems is taken into account.

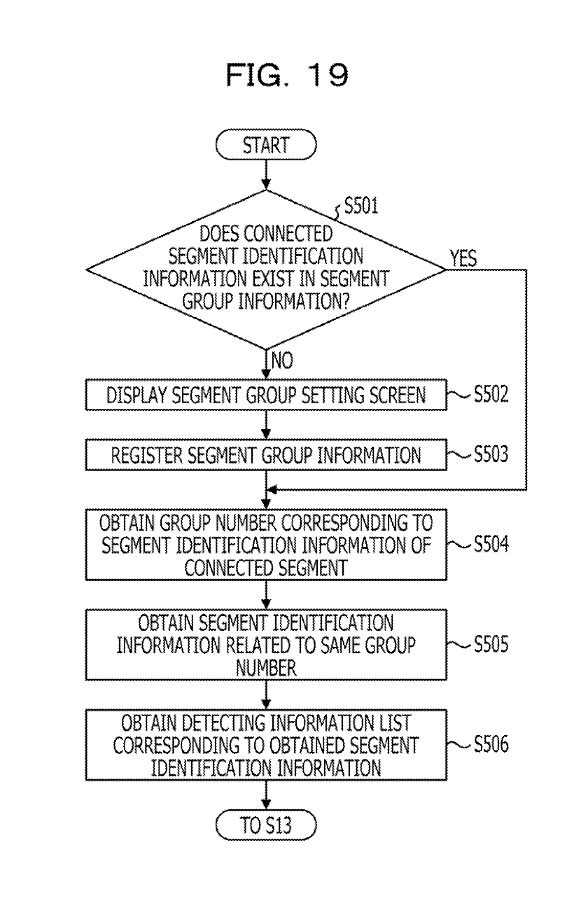

According to the third embodiment, a process procedure illustrated in FIG. 19 is added between step S12 and step S13 in FIG. 4.

FIG. 19 is a flow chart for describing an example of a process procedure added according to the third embodiment.

In step S501, the detecting information extraction unit 124 determines whether or not the segment group information related to the segment identification information of the network segment sg where the mobile terminal 10 is connected is recorded in the segment group information storage unit 125.

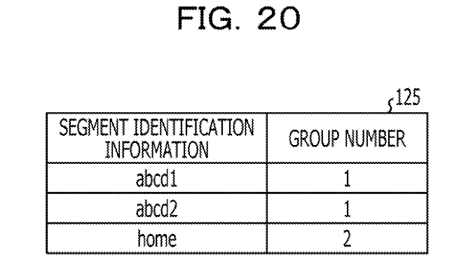

FIG. 20 illustrates a configuration example of the segment group information storage unit. The segment group information storage unit 125 stores a group number of the segment group to which the network segment sg related to the relevant segment identification information belongs for each piece of the segment identification information. The group numbers are numbers for identifying the respective segment groups. In the example of the same drawing, the two network segments sg belong to the segment group having a group number 1, and one network segment sg belong to the segment group having a group number 2. The content of the segment group information storage unit 125 is registered in step S503 which will be described below. Therefore, in the mobile terminal 10, in a case where step S503 is not executed even once, the content of the segment group information storage unit 125 is empty. However, at an asynchronous timing from the process of FIG. 19, the content of the segment group information storage unit 125 may be registered in advance.

In a case where the segment group information related to the segment identification information of the currently connected network segment sg is not recorded in the segment group information storage unit 125 (S501: No), the detecting information extraction unit 124 displays a segment group setting screen on the display apparatus 106 (S402). The segment group setting screen refers to a screen for querying about the permit or denial for the execution of the detection process in the currently connected network segment sg.

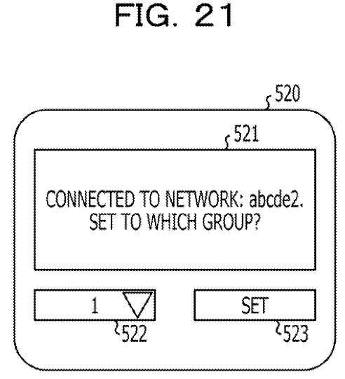

FIG. 21 illustrates a display example of a segment group setting screen. A segment group setting screen 520, a message 521, a combo box 522, a setting button 523, and the like.

The message 521 is a query as to which segment group the currently connected network segment sg is classified into (belongs to). The combo box 522 is a combo box for setting the segment group for classifying the currently connected network segment sg. That is, a list of the group numbers recorded in the segment group information storage unit 125 is displayed on the combo box 522. Also, it is also possible to input a group number that is not included in the relevant list in the combo box 522. The setting button 523 is a button for accepting a decision instruction of the setting content of the combo box 522.

When a selection of the group number is carried out and the setting button 523 is pressed in the segment group setting screen 520, the detecting information extraction unit 124 registers (records) the setting content in the segment group setting screen 520 in the segment group information storage unit 125 (S503). That is, the segment group information including the segment identification information of the currently connected network segment sg and the group number set in the combo box 522 is registered in the segment group information storage unit 125.

Following step S503 or the case of Yes in step S501, the detecting information extraction unit 124 obtains the segment group number related to the segment identification information of the currently connected network segment sg from the segment group information storage unit 125 (S504). Subsequently, the detecting information extraction unit 124 obtains the segment identification information associated with the obtained group number from the segment group storage unit (S505).

Subsequently, the detecting information extraction unit 124 obtains a list of the detecting information related to the obtained segment identification information from the detecting information storage unit 121 (S506). After that, step S13 is executed. However, in step S101 in FIG. 5 where the content of step S13 is described in detail, a parent population for the obtainment of the detecting information is set as the list of the detecting information obtained (extracted) in step S506.

According to the present embodiment, for example, it is conceivable that the respective network segments sg of the network system 1 are classified into a first segment group, and the respective network segments sg belonging to the network system 2 are classified into a second segment group. With this configuration, in a case where the mobile terminal 10 is connected to any network segment sg in the network system 1, the transmission destination of the unicast M-Search can be limited to the controlled device in the network system 1. Also, in a case where the mobile terminal 10 is connected to any network segment sg in the network system 2, the transmission destination of the unicast M-Search can be limited to the controlled device in the network system 2.

As described above, according to the third embodiment, it is possible to appropriately sort out the network environment where the unicast M-Search is transmitted. As a result, it is possible to reduce the probability of the degradation in the security or the like which is caused by the random transmission of the unicast M-Search.

In the above, the example has been described in which the mobile terminal 10 is connected to the controlled device by the wireless LAN communication. However, the mobile terminal 10 may be utilized while being connected to a wired LAN. In this case, the segment identification information may be set as a MAC address of a router related to the wired LAN to which the mobile terminal 10 is connected. Alternatively, if a DHCP (Dynamic Host Configuration Protocol) server is arranged for each of the network segments sg, an IP address or a MAC address of the DHCP server may be set as the segment identification information.

In the above, the embodiments of the present invention have been described in detail, but the present invention is not limited to the above-mentioned particular embodiments, and various modifications and alterations can be made within the description of the present invention as described by the scope of claims.

According to the above-mentioned embodiments, it is possible to appropriately avoid a situation in which the detection range of the device is limited by the network segment.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments of the present inventions have been described in detail, it should be understood that the various changes, substitutions, and alterations could be made hereto without departing from the spirit and scope of the invention.

What is claimed is:

1. A device detection apparatus comprising:
a multicast detection unit that uses multicast to detect a device and records address information of the detected device in a first storage unit while being associated with identification information of a currently connected network segment; and
a unicast detection unit that detects the device related to the address information associated with the identification information which is different from the identification information of the currently connected network segment among the address information recorded in the first storage unit.

2. The device detection apparatus according to claim 1, further comprising:
a second storage unit that stores device information which is included in a response replied from the detected device and includes a validity time limit; and
a deletion unit that deletes the device information when the validity time limit elapses, from the second storage unit,
wherein the unicast detection unit invalidates the validity time limit of the device information included in the response replied from the device and records the device information in the second storage unit.

3. The device detection apparatus according to claim 1, further comprising:
a permit denial information storage unit that stores information indicating a permit or denial of a detection of the device for each of the identification information of the network segments; and
a determination unit that determines the permit or denial of the detection of the device based on the permit denial information stored in the permit denial information storage unit related to the identification information of the currently connected network segment,
wherein the unicast detection unit detects the device when the determination unit determines that the detection is permitted.

4. The device detection apparatus according to claim 1, further comprising:
a group information storage unit that stores information indicating a group for classifying the network segment for each of the identification information of the network segments; and
an extraction unit that obtains identification information of the network segment belonging to the same group as the currently connected network segment from the group information storage unit and extracts the address information associated with the obtained identification information from the first storage unit,
wherein the unicast detection unit detects the device related to the address information associated with the identification information different from the identification information of the currently connected network segment among the address information extracted by the extraction unit.

5. A non-transitory computer-readable recording medium that stores a program for causing a computer to execute a process comprising:
using multicast to detect a device and recording address information of the detected device in a first storage unit while being associated with identification information of a currently connected network segment; and
detecting the device related to the address information associated with the identification information which is different from the identification information of the currently connected network segment among the address information recorded in the first storage unit.

6. The non-transitory computer-readable recording medium that stores a program for causing a computer to execute a process according to claim 5, further comprising:
deleting from a second storage unit that stores device information which is included in a response replied from the detected device and includes a validity time limit, the device information when the validity time limit elapses,
wherein the process of detecting the device includes invalidating the validity time limit of the device information included in the response replied from the device and recording the device information in the second storage unit.

7. The non-transitory computer-readable recording medium that stores a program for causing a computer to execute a process according to claim 5, further comprising:
using a permit denial information storage unit that stores information indicating a permit or denial of a detection of the device for each of the identification information of the network segments related to the identification information of the currently connected network segment and determining the permit or denial of the detection,
wherein the process of detecting the device includes detecting the device when it is determined that the detection is permitted.

8. The non-transitory computer-readable recording medium that stores a program for causing a computer to execute a process according to claim 5, further comprising:
obtaining, from a group information storage unit that stores information indicating a group for classifying the network segment for each of the identification information of the network segments, identification information of the network segment belonging to the same group as the currently connected network segment from the group information storage unit and extracting the address information associated with the obtained identification information from the first storage unit,
wherein the process of detecting the device includes detecting the device related to the address information associated with the identification information different from the identification information of the currently connected network segment among the extracted address information.
